(19) United States
(12) Patent Application Publication
(10) Pub. No.: US 2024/0269769 A1
(43) Pub. Date: Aug. 15, 2024

(54) LASER PROCESSING METHOD AND LASER PROCESSING SYSTEM

(71) Applicant: Gigaphoton Inc., Tochigi (JP)

(72) Inventor: Takashi ONOSE, Oyama-shi (JP)

(73) Assignee: Gigaphoton Inc., Tochigi (JP)

(21) Appl. No.: 18/599,445

(22) Filed: Mar. 8, 2024

Related U.S. Application Data
(63) Continuation of application No. PCT/JP2021/039062, filed on Oct. 22, 2021.

(51) Int. Cl. B23K 26/073; B23K 26/06; B23K 103/00

(52) U.S. Cl. CPC B23K 26/073; B23K 26/0648; B23K 2103/52

(57) ABSTRACT

A laser processing method includes a first process to concentrate laser light on a front surface of a workpiece to form a recessed portion, and a second process to concentrate the laser light on a bottom surface of the recessed portion. In the second process, a fluence Fin satisfies an expression of Ffth<Fin<Fmth, where Fin represents a fluence of the laser light at an upper end of the recessed portion, Ffth represents a fluence being an upper limit with which a film is formed by a chemical reaction between the workpiece and the atmosphere due to irradiation with the laser light, and Fmth represents a fluence being a lower limit with which the laser light is capable of processing the workpiece.

### CROSS-REFERENCE TO RELATED APPLICATIONS

The present application claims the benefit of International Application No. PCT/JP2021/039062, filed on Oct. 22, 2021, the entire contents of which are hereby incorporated by reference.

### BACKGROUND

### 1. Technical Field

The present disclosure relates to a laser processing method and a laser processing system.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as the gas laser device for exposure, a KrF excimer laser device that outputs laser light having a wavelength of about 246.0 nm and an ArF excimer laser device that outputs laser light having a wavelength of about 193.4 nm are used.

The KrF excimer laser device and the ArF excimer laser device each have a large spectral line width of about 350 pm to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: U.S. Pat. No. 7,837,925

Patent Document 2: Japanese Patent Application Publication No. H3-157917

### SUMMARY

A laser processing method according to an aspect of the present disclosure includes a first process to concentrate laser light on a front surface of a workpiece to form a recessed portion, and a second process to concentrate the laser light on a bottom surface of the recessed portion. In the second process, a fluence Fin satisfies an expression of Ffth<Fin<Fmth, where Fin represents a fluence of the laser light at an upper end of the recessed portion, Ffth represents a fluence being an upper limit with which a film is formed by a chemical reaction between the workpiece and the atmosphere due to irradiation with the laser light, and Fmth represents a fluence being a lower limit with which the laser light is capable of processing the workpiece.

A laser processing system according to an aspect of the present disclosure includes an optical system which radiates laser light, and an fθ lens which concentrates the laser light traveling from the optical system on a front surface of a workpiece. Here, the optical system performs irradiation with the laser light having a fluence Fin which satisfies an expression of Ffth<Fin<Fmth where Fin represents a fluence of the laser light at an upper end of a recessed portion to be formed by concentration of the laser light on the front surface, Ffth represents a fluence being an upper limit with which a film is formed by a chemical reaction between the workpiece and the atmosphere due to irradiation with the laser light, and Fmth represents a fluence being a lower limit with which the laser light is capable of processing the workpiece.

### BRIEF DESCRIPTION OF THE DRAWINGS

Embodiments of the present disclosure will be described below merely as examples with reference to the accompanying drawings.

FIG. 1 is a schematic diagram showing a schematic configuration example of an entire laser processing system of a comparative example.

FIG. 2 is an explanatory view of a recessed portion and a processing portion to be a through hole.

FIG. 3 is an explanatory view of a case in which a wall surface on an upper end side of the recessed portion is irradiated with laser light.

FIG. 4 is an explanatory view of an effective processing depth and a cross-sectional area of laser light.

FIG. 5 is a graph showing a spectral waveform of laser light of spontaneous oscillation and light absorption by oxygen.

FIG. 6 is a diagram showing a control flowchart of a laser processing processor of a first embodiment.

FIG. 7 is an explanatory view of concentrating laser light on a front surface of a workpiece.

FIG. 8 is an explanatory view of helical processing.

FIG. 9 is an explanatory view of a first process.

FIG. 10 is an explanatory view of a second process.

FIG. 11 is an explanatory view of a processing portion formed at the workpiece.

FIG. 12 is a schematic diagram showing a schematic configuration example of the entire laser processing system of a second embodiment.

FIG. 13 is a schematic view showing a schematic configuration example of a variable beam expander.

FIG. 14 is a diagram showing a control flowchart of the laser processing processor of the second embodiment.

FIG. 15 is a diagram showing a control flowchart of the laser processing processor of a third embodiment.

FIG. 16 is an explanatory view of concentrating laser light on the front surface of the workpiece in step SP31.

FIG. 17 is an explanatory view of a case in which the wall surface on the upper end side of the recessed portion is irradiated with laser light in the third embodiment.

FIG. 18 is an explanatory view of a case in which a bottom surface of the recessed portion is irradiated with laser light in step S37.

FIG. 19 is a schematic view showing a schematic configuration example of the entire gas laser device of a modification.

### DESCRIPTION OF EMBODIMENTS

1. Description of laser processing system and laser processing method of comparative example
1.1 Configuration
1.2 Operation
1.3 Problem

2. Description of effective processing depth of workpiece and cross-sectional area of laser light

3. Description of laser processing system and laser processing method of first embodiment
3.1 Configuration
3.2 Operation
3.3 Effect

4. Description of laser processing system and laser processing method of second embodiment
4.1 Configuration
4.2 Operation
4.3 Effect

5. Description of laser processing system and laser processing method of third embodiment
5.1 Configuration
5.2 Operation
5.3 Effect

6. Description of gas laser device of modification

Hereinafter, embodiments of the present disclosure will be described in detail with reference to the drawings.

The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Description of Laser Processing System and Laser Processing Method of Comparative Example

### 1.1 Configuration

A laser processing system and a laser processing method of a comparative example will be described. The comparative example of the present disclosure is an example recognized by the applicant as known only by the applicant, and is not a publicly known example admitted by the applicant.

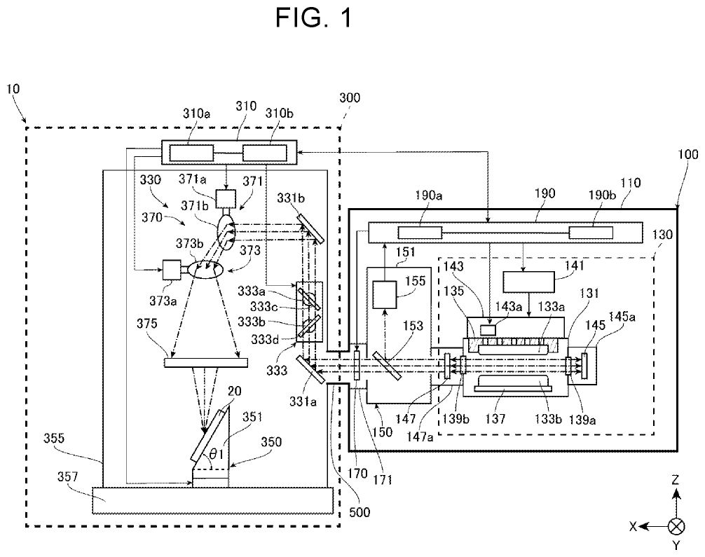

FIG. 1 is a schematic diagram showing a schematic configuration example of an entire laser processing system 10. The laser processing system 10 includes a gas laser device 100, a laser processing device 300, and an optical path pipe 500 that connects the gas laser device 100 and the laser processing device 300 as a main configuration. In the following, a direction parallel to the optical axis direction of laser light incident on a workpiece 20 is described as a Z direction, a direction perpendicular to the Z direction is described as an X direction, and a direction perpendicular to the X direction and the Z direction is described as a Y direction.

The gas laser device 100 is, for example, an ArF excimer laser device using a mixed gas including argon (Ar), fluorine (F₂), and neon (Ne). The gas laser device 100 outputs laser light having a center wavelength of about 193.4 nm. Here, the gas laser device 100 may be a gas laser device other than the ArF excimer laser device, and may be, for example, a KrF excimer laser device using a mixed gas including krypton (Kr), F₂, and Ne. In this case, the gas laser device 100 outputs laser light having a center wavelength of about 246.0 nm. The mixed gas containing Ar, F₂, and Ne which is a laser medium and the mixed gas containing Kr, F₂, and Ne which is a laser medium may be referred to as a laser gas.

The gas laser device 100 includes a housing 110, a laser oscillator 130 arranged at the internal space of the housing 110, a monitor module 150, a shutter 170, and a laser processor 190 as a main configuration.

The laser oscillator 130 includes a laser chamber 131, a charger 141, a pulse power module 143, a rear mirror 145, and an output coupling mirror 147. In FIG. 1, the internal configuration of the laser chamber 131 is shown as viewed from a direction substantially perpendicular to the travel direction of the laser light.

The laser chamber 131 includes an internal space in which light is generated by excitation of a laser medium in the laser gas. This light travels to windows 139a, 139b described later. The laser gas is supplied from a laser gas supply source (not shown) to the internal space of the laser chamber 131 through a pipe (not shown). Further, the laser gas in the laser chamber 131 is subjected to a process of removing the F₂ gas by a halogen filter or the like, and is exhausted to the housing 110 through a pipe (not shown) by an exhaust pump (not shown).

At the internal space of the laser chamber 131, a pair of electrodes 133a, 133b are arranged to face each other and each have a longitudinal direction along the travel direction of the light. The electrodes 133a, 133b are discharge electrodes for exciting the laser medium by glow discharge. In the present example, the electrode 133a is the cathode and the electrode 133b is the anode.

The electrode 133a is supported by an electrically insulating portion 135. The electrically insulating portion 135 blocks an opening formed in the laser chamber 131. A conductive portion (not shown) is embedded in the electrically insulating portion 135, and the conductive portion applies a high voltage supplied from the pulse power module 143 to the electrode 133a. The electrode 133b is supported by a return plate 137, and the return plate 137 is connected to the inner surface of the laser chamber 131 by a wire (not shown).

The charger 141 is a DC power source device that charges a charging capacitor (not shown) in the pulse power module 143 with a predetermined voltage. The pulse power module 143 includes a switch 143a controlled by the laser processor 190. When the switch 143a is turned ON from OFF, the pulse power module 143 generates a pulse high voltage from the electric energy held in the charger 141 and applies the high voltage between the electrode 133a and the electrode 133b.

When the high voltage is applied between the electrode 133a and the electrode 133b, discharge occurs between the electrode 133a and the electrode 133b. The laser medium in the laser chamber 131 is excited by the energy of the discharge, and the excited laser medium emits light when shifting to the ground state.

The laser chamber 131 is provided with the windows 139a, 139b. The window 139a is located at one end side of the laser chamber 131 in the travel direction of the laser light, the window 139b is located at the other end side in the travel direction, and the windows 139a, 139b sandwich a space between the electrode 133a and the electrode 133b. The windows 139a, 139b are inclined at the Brewster angle with respect to the travel direction of the laser light so that P-polarized light of the laser light is suppressed from being reflected. The laser light oscillated as described later is output to the outside of the laser chamber 131 through the windows 139a, 139b. Since a pulse high voltage is applied between the electrode 133a and the electrode 133b by the pulse power module 143 as described above, the laser light is pulse laser light.

The rear mirror 145 is arranged at the internal space of a housing 145a connected to the one end side of the laser chamber 131, and reflects the laser light output from the window 139a to return the laser light to the laser chamber 131. The output coupling mirror 147 is arranged at the internal space of an optical path pipe 147a connected to the other end side of the laser chamber 131, transmits a part of the laser light output from the window 139b, and reflects the other part of the laser light to return to the internal space of the laser chamber 131. Thus, the rear mirror 145 and the output coupling mirror 147 configure a Fabry-Perot laser resonator, and the laser chamber 131 is arranged on the optical path of the laser resonator.

The monitor module 150 is arranged on the optical path of the laser light output from the output coupling mirror 147. The monitor module 150 includes, for example, a housing 151, and a beam splitter 153 and an optical sensor 155 arranged at the internal space of the housing 151. An opening is formed in the housing 151, and the internal space of the housing 151 communicates with the internal space of the optical path pipe 147a via the opening.

The beam splitter 153 transmits a part of the laser light output from the output coupling mirror 147 toward the shutter 170, and reflects another part of the laser light toward a light receiving surface of the optical sensor 155. The optical sensor 155 measures an energy E of the laser light incident on the light receiving surface. The optical sensor 155 outputs a signal indicating the measured energy E to the laser processor 190.

The laser processor 190 of the present disclosure is a processing device including a storage device 190a in which a control program is stored and a central processing unit (CPU) 190b that executes the control program. The laser processor 190 is specifically configured or programmed to perform various processes included in the present disclosure. The laser processor 190 controls the entire gas laser device 100.

The laser processor 190 transmits and receives various signals to and from a laser processing processor 310 of the laser processing device 300. For example, the laser processor 190 receives a later-described light emission trigger Tr and a later described target energy Et from the laser processing processor 310. The laser processor 190 controls the charge voltage of the charger 141 based on the energy E and the target energy Et received from the optical sensor 155 and the laser processing processor 310. By controlling the charge voltage, the energy of the laser light is controlled. Further, the laser processor 190 transmits a command signal of ON or OFF of the switch 143a to the pulse power module 143. The laser processor 190 is electrically connected to the shutter 170 and controls opening and closing of the shutter 170.

The laser processor 190 closes the shutter 170 until a difference ΔE between the energy E received from the monitor module 150 and the target energy Et received from the laser processing processor 310 falls within an allowable range. When the difference ΔE falls within the allowable range, the laser processor 190 transmits, to the laser processing processor 310, a reception preparation completion signal indicating that reception preparation of the light emission trigger Tr is completed. The laser processing processor 310 transmits a signal indicating the light emission trigger Tr to the laser processor 190 when receiving the reception preparation completion signal, and the laser processor 190 opens the shutter 170 when receiving the signal indicating the light emission trigger Tr. The light emission trigger Tr is defined by a predetermined repetition frequency f and a predetermined number of pulses P of the laser light, is a timing signal for the laser processing processor 310 to cause the laser oscillator 130 to perform laser oscillation, and is an external trigger. The repetition frequency f of the laser light is, for example, 1 kHz or more and 10 kHz or less.

The shutter 170 is arranged on the optical path of the laser light transmitted through the beam splitter 153 of the monitor module 150 and having passed through an opening formed on the side of the housing 151 opposite to the side to which the optical path pipe 147a is connected. Further, the shutter 170 is arranged at the internal space of the optical path pipe 171, and the optical path pipe 171 is connected to the housing 151 to surround the opening and is in communication with the housing 151. Further, the optical path pipe 171 is in communication with the laser processing device 300 through the opening of the housing 110 and the optical path pipe 500.

The internal spaces of the optical path pipe 171 and the optical path pipe 147a and the internal spaces of the housing 151 and the housing 145a are filled with a purge gas. The purge gas includes an inert gas such as nitrogen (N₂). The purge gas is supplied from a purge gas supply source (not shown) to the internal spaces of the optical path pipe 171 and the optical path pipe 147a and the internal spaces of the housing 151 and the housing 145a through pipes (not shown).

The laser processing device 300 includes a laser processing processor 310, a housing 355, a frame 357, and an optical system 330, an fθ lens 375, and a stage 350 arranged at the internal space of the housing 355 as a main configuration. The housing 355 is fixed to the frame 357. An optical path pipe 500 is connected to the housing 355, and the internal space of the housing 355 is in communication with the internal space of the optical path pipe 500 through the opening of the housing 355, and the laser light transmitted through the shutter 170 enters the housing 355.

The laser processing processor 310 is a processing device including a storage device 310a in which a control program is stored and a CPU 310b that executes the control program. The laser processing processor 310 is specifically configured or programmed to perform various processes included in the present disclosure. Further, the laser processing processor 310 controls the entire laser processing device 300.

The optical system 330 includes high reflection mirrors 331a, 331b, an attenuator 333, and an irradiation optical system 370. Each of the high reflection mirrors 331a, 331b, the attenuator 333, and the irradiation optical system 370 is fixed to a holder (not shown), and is arranged at a predetermined position in the housing 355.

The high reflection mirrors 331a, 331b are each formed by coating a reflection film that highly reflects laser light on the surface of a transparent substrate formed of, for example, synthetic quartz or calcium fluoride. The high reflection mirror 331a reflects, toward the attenuator 333, the laser light incident from the gas laser device 100. The high reflection mirror 331b reflects the laser light from the attenuator 333 toward the irradiation optical system 370.

The attenuator 333 is arranged on the optical path between the high reflection mirror 331a and the high reflection mirror 331b. The attenuator 333 includes, for example, rotation stages 333a, 333b and partial reflection mirrors 333c, 333d fixed to the rotation stages 333a, 333b. Each rotation stage 333a, 333b is electrically connected to the laser processing processor 310 and rotates about the Y axis by a control signal from the laser processing processor 310. When the rotation stages 333a, 333b rotate, the partial reflection mirrors 333c, 333d also rotate. The partial reflection mirrors 333c, 333d are optical elements in which the transmittances of the partial reflection mirrors 333c, 333d vary depending on the incident angles of the laser light on the partial reflection mirrors 333c, 333d. The rotation angles of the partial reflection mirrors 333c, 333d about the Y axis are adjusted by the rotation of the rotation stages 333a, 333b so that the incident angles of the laser light coincide with each other and the transmittances of the partial reflection mirrors 333c, 333d become desired transmittances. Accordingly, the laser light from the high reflection mirror 331a is attenuated to a desired energy and passes through the attenuator 333.

The irradiation optical system 370 guides the laser light output from the gas laser device 100 to the workpiece 20, moves the irradiation spot of the guided laser light in the in-plane direction of a projection surface of the workpiece 20, and radiates the laser light. The projection surface is a surface located on the XY plane when the workpiece 20 is viewed from a direction opposite to the travel direction of the laser light to the workpiece 20. In the irradiation with the laser light in the present embodiment, the laser light moves in the XY plane. The irradiation optical system 370 includes galvano scanners 371, 373.

The galvano scanner 371 includes a drive unit 371a and a mirror 371b mounted on a swing shaft of the drive unit 371a and swingable about the swing shaft. The configuration of the galvano scanner 373 is the same as that of the galvano scanner 371, and the galvano scanner 373 includes a drive unit 373a and a mirror 373b mounted on a swing shaft of the drive unit 373a and swingable about the swing shaft.

The drive units 371a, 373a are motors or the like, and are electrically connected to the laser processing processor 310. The swing speed and the swing angle of the swing shaft of each of the drive units 371a, 373a are controlled by control signals from the laser processing processor 310. The swing shaft of the drive unit 371a is perpendicular to the swing shaft of the drive unit 373a.

The mirror 371b reflects the laser light from the high reflection mirror 331b toward the mirror 373b, and the mirror 373b reflects the laser light from the mirror 371b toward the fθ lens 375. The respective orientations of the mirrors 371b, 373b are adjusted by the swing angles of the respective swing shafts of the drive units 371a, 373a. The adjustment of the respective orientations of the mirrors 371b, 373b may be synchronized with each other. The speed of each of the mirrors 371b, 373b at the time of swinging is adjusted by the swing speed at the time of swinging of the swing shaft of each of the drive units 371a, 373a.

The galvano scanners 371, 373 as described above irradiate the workpiece 20 with the laser light while moving the laser light in the X direction and the Y direction by the mirrors 371b, 373b, and process the workpiece 20 by the movement and irradiation. In the movement and irradiation, the distance between irradiation lines and the movement speed of the laser light to irradiate the workpiece 20 are controlled by the orientations and the speed of the mirrors 371b, 373b. The irradiation line is a line in which the irradiation spot of the laser light moves on the workpiece 20.

The fθ lens 375 is fixed to a holder (not shown) on an optical path between the mirror 373b and the workpiece 20, and is arranged at a predetermined position in the housing 355. The optical axis of the fθ lens 375 is along the Z direction. The fθ lens 375 concentrates the laser light radiated from the galvano scanner 373 of the optical system 330 onto the surface of the workpiece 20 along the optical axis of the fθ lens 375. Further, the fθ lens 375 concentrates the laser light on the workpiece 20 so that the irradiation spot diameter of the laser light on the workpiece 20 is smaller than the diameter of a processing portion to be formed on the workpiece 20.

The stage 350 is arranged on the bottom surface of the housing 355 and includes a table 351. Further, the stage 350 can move the table 351 in the X direction, the Y direction, and the Z direction by a control signal from the laser processing processor 310, and can adjust the position of the table 351 by this movement.

The table 351 supports the workpiece 20. The front surface and the back surface, which are main surfaces of the table 351, are inclined with respect to the XY plane. Therefore, the front surface and the back surface of the workpiece 20 are inclined with respect to the optical axis direction of the laser light, so that oblique hole processing is performed. In FIG. 1, the inclination angle of the back surface of the workpiece 20 with respect to the XY plane is defined as an inclination angle θ1. With the above configuration, the stage 350 can adjust the position of the workpiece 20 by moving the workpiece 20 via the table 351 so that a desired position of the workpiece 20 is irradiated with the laser light output from the optical system 330.

The workpiece 20 is an object on which laser processing is performed by radiating the laser light. Examples of the workpiece 20 include quartz glass. Further, examples of the workpiece 20 include a material containing carbon atoms, an organic material such as polyimide and a fluorine-based resin, a carbon fiber reinforced plastics (CFRP) of carbon fibers and a resin, and diamond. Further, examples of the workpiece 20 include a wide-bandgap material such as sapphire and silicon carbide (SiC), a CaF₂crystal, an MgF₂ crystal, and a transparent material such as a glass material.

An inert gas constantly flows at the internal space of the housing 355 during operation of the laser processing system 10. The inert gas is, for example, a nitrogen gas. The housing 355 is provided with a suction port (not shown) for sucking the inert gas into the housing 355, and an exhaust port (not shown) for exhausting the inert gas from the housing 355 to the outside. A suction pipe (not shown) and an exhaust pipe (not shown) are connected to the suction port and the exhaust port, respectively. A gas supply source (not shown) for supplying the inert gas is connected to the suction port through the suction pipe. The inert gas supplied from the suction port also flows to the optical path pipe 500 communicating with the housing 355.

### 1.2 Operation

Next, operation of the laser processing system 10 of the comparative example will be described.

Before the gas laser device 100 outputs the laser light, a purge gas is filled from a purge gas supply source (not shown) into the internal spaces of the optical path pipes 147a, 171, 500 and the internal spaces of the housings 145a, 151 in the gas laser device 100. Further, a laser gas is supplied to the internal space of the laser chamber 131 from a laser gas supply source (not shown). In the laser processing device 300, an inert gas such as a nitrogen gas flows at the internal space of the housing 355.

In the laser processing device 300, the workpiece 20 is supported on the table 351. The laser processing processor 310 sets, to the stage 350, a coordinate X, a coordinate Y, and a coordinate Z of an initial irradiation position to be irradiated with the laser light to form a processing portion. Thus, the stage 350 moves the table 351 to a set initial irradiation position together with the workpiece 20.

After the table 351 is moved, the laser processing processor 310 controls the orientations of the mirrors 371b, 373b by the drive units 371a, 373a of the galvano scanners 371, 373 so that the initial irradiation position is irradiated with the laser light. Further, the laser processing processor 310 controls the gas laser device 100 and the transmittance of the attenuator 332 of the optical system 330 so that the laser light radiated to the workpiece 20 has a desired fluence F required for laser processing. The fluence F is defined as a value obtained by dividing the energy of the laser light by the cross-sectional area of the laser light perpendicular to the optical axis of the laser light.

The laser processor 190 closes the shutter 170 and drives the charger 141. Further, the laser processor 190 turns ON the switch 143a of the pulse power module 143. Thus, the pulse power module 143 applies a pulse high voltage from the electric energy held in the charger 141 between the electrode 133a and the electrode 133b. The high voltage causes discharge between the electrode 133a and the electrode 133b, the laser medium contained in the laser gas between the electrode 133a and the electrode 133b is brought into an excited state, and light is emitted when the laser medium returns to the ground state. The light resonates between the rear mirror 145 and the output coupling mirror 147, and is amplified every time it passes through the discharge space at the internal space of the laser chamber 131, thereby causing laser oscillation. Then, a part of the laser light is transmitted through the output coupling mirror 147 as pulse laser light and travels to the beam splitter 153.

A part of the laser light having traveled to the beam splitter 153 is reflected by the beam splitter 153 and received by the optical sensor 155. The optical sensor 155 measures the energy E of the received laser light, and outputs a signal indicating the energy E to the laser processor 190. The laser processor 190 controls the charge voltage so that the difference ΔE between the energy E and the target energy Et falls within the allowable range, and after the difference ΔE falls within the allowable range, the laser processor 190 transmits, to the laser processing processor 310, the reception preparation completion signal indicating that reception preparation of the light emission trigger Tr is completed.

Upon receiving the reception preparation completion signal, the laser processing processor 310 transmits the light emission trigger Tr to the laser processor 190. When the laser processor 190 opens the shutter 170 in synchronization with the reception of the light emission trigger Tr, the laser light that has passed through the shutter 170 enters the laser processing device 300. The laser light is, for example, pulse laser light having a center wavelength of 193.4 nm.

The laser light having entered the laser processing device 300 travels to the fθ lens 375 through the high reflection mirror 331a, the attenuator 333, the high reflection mirror 331b, and the irradiation optical system 370, and is concentrated on the workpiece 20 by the fθ lens 375.

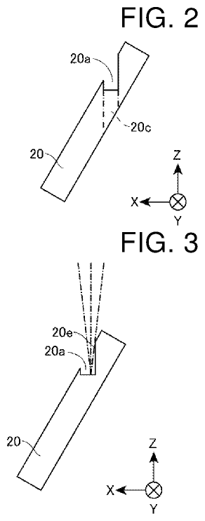

The laser light is radiated to the workpiece 20 in accordance with the light emission trigger Tr defined by the repetition frequency f and the number of pulses P required for laser processing. When the irradiation with the laser light is continued, ablation occurs in the vicinity of the top surface of the workpiece 20 and a defect occurs. As a result, as shown in FIG. 2, a recessed portion 20a is formed on the top surface of the workpiece 20. Further, when the laser light is further concentrated on the bottom surface of the recessed portion 20a, a processing portion 20c such as a through hole is formed. In FIG. 2, to distinguish the recessed portion 20a and the processing portion 20c, the processing portion 20c is indicated by a dashed-dotted line.

In a case in which, after the processing portion 20c is formed, another processing portion 20c is to be formed on another part of the workpiece 20, the laser processing processor 310 sets, to the stage 350, a coordinate X, a coordinate Y, and a coordinate Z of an initial irradiation position to be irradiated with the laser light to form the other processing portion 20c. Thus, the stage 350 moves to the set initial irradiation position together with the workpiece 20. Thereafter, laser processing is performed on the workpiece 20 at the coordinates. When another processing portion 20c is not to be formed, laser processing is terminated. Such a procedure is repeated until laser processing for all processing portions 20c is completed. In the present example, the workpiece 20 is processed until a plurality of the processing portions 20c are formed.

### 1.3 Problem

At the last phase of the processing by the laser processing device 300 of the comparative example, the processing depth of the recessed portion 20a becomes deep, and the cross-sectional area of the laser light perpendicular to the optical axis is increased at the upper end side of the recessed portion 20a as compared with the concentration position of the laser light at the bottom surface side of the recessed portion 20a. The fluence of the laser light becomes lower compared with the concentration position as the cross-sectional area becomes large. Then, as shown in FIG. 3, when a wall surface 20e on the upper end side of the recessed portion 20a is irradiated with the laser light having lowered fluence, the wall surface 20e chemically reacts with the atmosphere in which the workpiece 20 is arranged, and a film (not shown) may be formed on the wall surface 20e by the chemical reaction. Further, such a film may be formed at the irradiation position of the laser light by the chemical reaction as well even when the workpiece 20 other than the wall surface is irradiated with the laser light having lowered fluence. Incidentally, the workpiece 20 including a through hole may be covered with a protective film (not shown). In this case, the protective film also covers the film formed by the chemical reaction. When the film formed by the chemical reaction is peeled off from the wall surface 20e or the workpiece 20, the protective film may also be peeled off from the workpiece 20 due to peeling of the film, and the workpiece 20 may not be protected by the protective film. Therefore, it has been requested to suppress formation of such a film. To suppress the formation of such a film, it is simply required to increase the fluence of the laser light at the upper end side. However, when the energy of the laser light is increased to increase the fluence, the workpiece 20 may be unnecessarily processed such that the upper end of the recessed portion 20a is cut.

Therefore, in the following embodiments, a laser processing system 10 and a laser processing method capable of suppressing film formation and unnecessary processing of the workpiece 20 are exemplified.

In the embodiments, the workpiece 20 is described as including a plurality of fibers and a matrix material, and examples of the workpiece 20 include a ceramic matrix composite (CMC). In this case, examples of the fibers include silicon carbide fibers, carbon fibers, silicon nitride fibers, alumina fibers, and boron nitride fibers. The fibers may be made of other suitable ceramics. Examples of the matrix material include silicon carbide. The workpiece 20 as described above is used as a component of an engine in the fields of aeronautics, space, automobiles, power generation, and the like, in which light weight, high strength, and heat resistance are required. Specifically, the workpiece 20 is used, for example, as at least a part of at least one of a shroud, a combustion liner, a fuel nozzle, a swirler, a compressor blade, and a turbine blade.

In the embodiments, the workpiece 20 has, for example, a plate shape, but the shape is not particularly limited. Further, the processing portion 20c formed in the workpiece 20 will be described as a through hole formed by oblique hole processing. The through hole communicates with a pipe (not shown) on the back surface of the workpiece 20, and the pipe communicates with a cooling source (not shown). The cooling source feeds cooling fluid through the pipe into the through hole. The fluid flows from the through hole to the front surface of the workpiece 20 and cools the front surface of the workpiece 20.

### 2. Description of Effective Processing Depth of Workpiece and Cross-Sectional Area of Laser Light

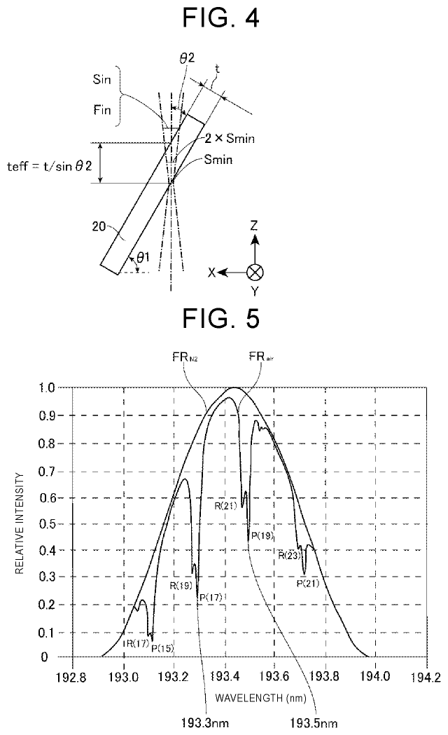

FIG. 4 is an explanatory view of an effective processing depth teff of the workpiece 20 to be obliquely processed and the cross-sectional area of the laser light. The effective processing depth teff is a length of the processing portion 20c in the optical axis direction formed by the oblique hole processing in the workpiece 20 in which the main surface is inclined with respect to the optical axis, specifically, the length from the front surface to the back surface of the workpiece 20 in the optical axis direction of the laser light. The effective processing depth teff is expressed as t/sinθ2, where the inclination angle of the front surface of the workpiece 20 with respect to the optical axis of the laser light is θ2 and the thickness of the workpiece 20 being a length in a direction perpendicular to the front surface being a main surface of the workpiece 20 is t. The inclination angle θ2 is an angle obtained by subtracting an inclination angle θ1 of the back surface of the workpiece 20 with respect to the XY plane from 90°. When the main surface of the workpiece 20 is perpendicular to the optical axis of the laser light along the XY plane instead of the oblique hole processing, the effective processing depth teff is equal to the thickness t of the workpiece 20.

In addition, in FIG. 4, the cross-sectional area of the laser light at the beam waist of the laser light is shown as a cross-sectional area Smin in the laser light traveling from the fθ lens 375 to the workpiece 20. The cross-sectional area Smin is the smallest cross-sectional area of the laser light. Further, in FIG. 4, the cross-sectional area of the laser light at a position separated from the beam waist in the direction opposite to the travel direction of the laser light by the Rayleigh length is shown as a cross-sectional area 2×Smin. Further, in FIG. 4, the cross-sectional area of the laser light at the upper end of the recessed portion 20a to be formed by concentrating the laser light to the workpiece 20 is shown as a cross-sectional area Sin. The cross-sectional area of the laser light increases in the order of the cross-sectional area Smin, the cross-sectional area 2×Smin, and the cross-sectional area Sin. In FIG. 4, the effective processing depth teff described above has a value satisfying 2×Smin<Sin and is larger than the Rayleigh length, when the beam waist is positioned on the back surface of the workpiece 20. Here, the effective processing depth teff may not have a value satisfying 2×Smin<Sin, and may be equal to or less than the Rayleigh length.

### 3. Description of Laser Processing System and Laser Processing Method of First Embodiment

Next, the laser processing system 10 and the laser processing method of a first embodiment will be described. Any component same as that described above is denoted by an identical reference sign, and duplicate description thereof is omitted unless specific description is needed.

### 3.1 Configuration

In the laser processing system 10 of the present embodiment, the laser processing processor 310 calculates the effective processing depth teff in advance, and the storage device 310a stores parameters.

The parameters include data indicating the relationship between each of the cross-sectional areas Sin, 2×Smin, Smin and a coordinate Z corresponding to the cross section. Here, the above relationship is described using the cross-sectional area, but may be described using the beam diameter of the laser light at the beam cross section instead of the cross-sectional area. Further, as a parameter of the present embodiment, a coordinate Z of the table 351 when the beam waist of the laser light is positioned on the front surface of the workpiece 20 is stored as Z0.

Further, the parameters include the fluence Fin shown in FIG. 4, a fluence Ffth, and a fluence Fmth. The fluence Fin is the fluence with the cross-sectional area Sin, that is, the fluence at the upper end of the recessed portion 20a. The fluence Fin is calculated by the laser processing processor 310 from the cross-sectional area Sin and the energy of the laser light. The fluence Ffth is an upper limit fluence with which a film (not shown) is formed on the workpiece 20 by a chemical reaction between the workpiece 20 and the atmosphere due to irradiation with the laser light. When the workpiece 20 is made of CMC, the fluence Ffth is set to 1 J/cm²or more and 2 J/cm² or less and preferably to 1.5 J/cm².

The fluence Fmth is a lower limit fluence with which the workpiece 20 can be processed by the laser light. Regarding the parameters described above, the cross-sectional areas Sin, 2×Smin, Smin and the coordinates Z corresponding to the cross sections may be measured in advance by sample processing of the workpiece 20, and the fluences Ffth, Fmth may also be calculated in advance from the sample processing. These sample processing are oblique hole processing.

Alternatively, the cross-sectional areas Sin, 2×Smin, Smin and the coordinates Z corresponding to the cross sections may be calculated from sample processing in which the workpiece 20 is irradiated with the laser light in a state that the main surface of the workpiece 20 is perpendicular to the optical axis of the laser light. In the sample processing, a plurality of workpieces 20 are prepared, and the coordinates Z at the beam waist of the laser light are set at different positions for the respective workpieces 20, so that the processing portion 20c is formed in each of the workpieces 20. When the processing portions 20c are formed, the cross-sectional area at the front surface of the workpiece 20 is measured for each of the processing portions 20c. An approximate curve is calculated from the relationship between the coordinates Z and the cross-sectional areas corresponding to the respective coordinates Z, and the cross-sectional areas Sin, 2×Smin, Smin and the corresponding coordinates Z are calculated from the approximate curve. Here, without calculating the approximate curve, the storage device 310a may store the relationship between the coordinates Z and the cross-sectional areas corresponding to the respective coordinates Z, and the laser processing processor 310 may calculate the cross-sectional areas Sin, 2×Smin, Smin from the relationship by the interpolation method.

In the above-described sample processing in which the workpiece 20 is irradiated with the laser light in a state that the main surface of the workpiece 20 is perpendicular to the optical axis, the cross-sectional areas Sin, 2×Smin, Smin may be calculated from the corresponding beam diameter of the laser light. The beam diameter can be calculated from the M² obtained from the relationship between the position of the beam waist of the laser light and the diameter of the processing portion 20c at the front surface of the workpiece 20. In the case in which the cross section of the laser light is elliptical, the M² in each of the major axis direction and the minor axis direction of the cross section may be obtained. In this case, the major axis direction, the minor axis direction, and the beam diameter at the coordinate Z may be calculated on the basis of each of the M² and the coordinate Z of the major axis direction and the minor axis direction of the cross section, and each of the cross-sectional areas Sin, 2×Smin, Smin of the laser light may be calculated as the product of the beam diameter in the major axis direction and the beam diameter in the minor axis direction.

Next, the wavelength of the laser light will be described. FIG. 5 shows a spectral waveform FR_{N2} of spontaneous oscillation (Free Running) of ArF excimer laser light in oxygen-free nitrogen gas. The center wavelength of the spectral waveform FR_{N2} is approximately 193.4 nm and the spectral line width is approximately 450.0 pm at full width at half maximum (FWHM). It is known that oxygen has a plurality of absorption lines that are absorption bands to absorb laser light. If a part of the spectral waveform FR_{N2} overlaps with the absorption line of oxygen in a gas containing oxygen, for example, in air, a portion of the laser light is absorbed by oxygen in the overlapped part. As a result, ozone is generated from the oxygen, and the ozone absorbs another portion of the laser light. When the absorption of the laser light occurs, in a spectral waveform FRₐᵢᵣ, a drop in the light intensity I occurs in the plurality of absorption lines as compared with the spectral waveform FR_{N2}. Here, the relative intensity on the vertical axis in FIG. 5 is a value obtained by normalizing the light intensity I.

For example, as described in Japanese Patent Application Publication H3-157917, the absorption lines between the wavelength 175.0 nm and the wavelength 250.0 nm are caused by absorption transitions in the Schumann-Runge band. The absorption lines correspond to absorption bands represented by branches R(17), P(15), R(19), P(17), R(21), P(19), R(23), and P(21). As shown in FIG. 5, in the spectral waveform FRₐᵢᵣ of ArF excimer laser light, the light intensity I falls at the absorption lines corresponding to the branches.

As described above, when the wavelength of the laser light overlaps the absorption line of oxygen in air, the intensity of the laser light decreases, and there arises a concern that the workpiece 20 is not properly processed. However, in the present embodiment, the inert gas flows into the internal space of the housing 355, oxygen is exhausted from the housing 355, and the overlap between the wavelength of the laser light and the absorption line of oxygen is suppressed. This suppresses generation of ozone and absorption of the laser light by ozone, and the workpiece 20 is irradiated with light having a decrease in the intensity of the laser light due to the absorption suppressed.

### 3.2 Operation

Next, operation of the laser processing processor 310 of the present embodiment will be described.

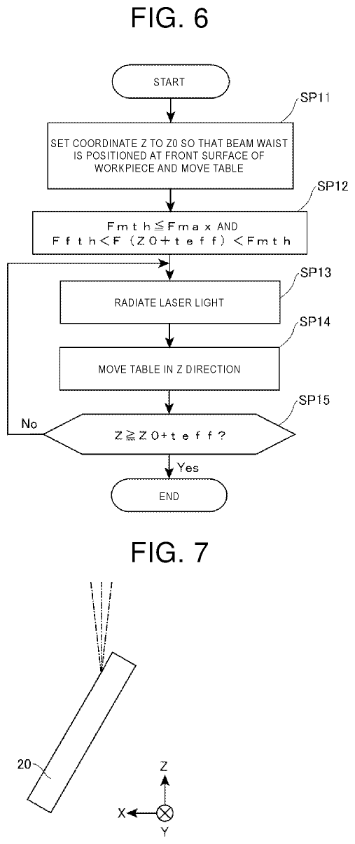

FIG. 6 is a diagram showing a control flowchart of the laser processing processor 310 of the present embodiment. The control flowchart of the present embodiment includes steps SP11 to SP15, and shows a laser processing method for forming the processing portion 20c on the workpiece 20.

In the start shown in FIG. 6, the laser processing processor 310 has received the reception preparation completion signal from the laser processor 190, but has not transmitted the light emission trigger Tr to the laser processor 190. Therefore, the laser light is output from the laser oscillator 130, but since the shutter 170 is closed, the laser light does not enter the laser processing device 300 from the gas laser device 100. Further, at the start, the workpiece 20 is already supported by the table 351, and the fluences Ffth, Fmth are calculated in advance.

### Step SP11

In the present step, the laser processing processor 310 sets the coordinate X and the coordinate Y of the irradiation position of the laser light for the stage 350 so that the processing portion 20c is formed at a desired position of the workpiece 20. Further, the laser processing processor 310 sets the coordinate Z of the table 351 to Z0 so that the beam waist of the laser light is positioned on the front surface of the workpiece 20 as shown in FIG. 7. When the setting is performed, the stage 350 moves the table 351 on which the workpiece 20 is placed so that the set position is irradiated with the laser light. When the movement of the table 351 is completed, the stage 350 transmits a signal indicating the completion to the laser processing processor 310. Upon receiving the signal, the laser processing processor 310 advances the control flow to step SP12.

### Step SP12

In the present step, when the current coordinate Z of the table 351 is Z0, that is, when the beam waist of the laser light is located on the front surface of the workpiece 20 as shown in FIG. 7, the laser processing processor 310 sets the energy of the laser light so that the fluence Fmax satisfies the expression of Fmax≥Fmth. The fluence Fmax is the fluence at the beam waist when the beam waist is positioned on the front surface of the workpiece 20 and is equal to a value obtained by dividing the energy of the laser light by the cross-sectional area Smin. Further, when the current coordinate Z of the table 351 is Z0+teff, that is, when the beam waist is positioned on the bottom surface of the recessed portion 20a where the processing depth is deepest, the laser processing processor 310 sets the energy of the laser light such that the fluence Fin satisfies the expression of Ffth<Fin=F(Z0+teff)<Fmth. The fluence F(Z0+teff) indicates the fluence Fin when the current coordinate Z of the table 351 is Z0+teff. Further, when the beam waist is positioned on the bottom surface of the recessed portion 20a, the laser processing processor 310 sets the energy of the laser light so that the fluence Fb satisfies the expression of Fb≥Fmth. The fluence Fb is the fluence at the beam waist, and similarly to the fluence Fmax, is equal to a value obtained by dividing the energy of the laser light by the cross-sectional area Smin. The laser processor 190 sets the energy of the laser light for each of the fluences Fin, Fmax, Fb from the fluences Ffth, Fmth calculated by the above-described sample processing. For setting the energy of the laser light, in the present embodiment, the laser processing processor 310 adjusts the transmittance of the attenuator 333 through which the laser light is transmitted. Therefore, the present step can be understood as a transmittance adjusting step to adjust the transmittance of the attenuator 333 through which the laser light is transmitted so that the fluence Fmax satisfies the expression of Fmax≥Fmth, the fluence Fin satisfies the expression of Ffth<Fin<Fmth, and the fluence Fb satisfies the expression of Fb≥Fmth. After adjusting the transmittance of the attenuator 333, the laser processing processor 310 advances the control flow to step SP13.

### Step SP13

The laser processing processor 310 transmits the light emission trigger Tr to the laser processor 190 and causes the laser processor 190 to open the shutter 170. As a result, the laser light enters the laser processing device 300 from the gas laser device 100. The laser light having entered travels in the order of the high reflection mirror 331a, the attenuator 333, the high reflection mirror 331b, the mirror 371b, the mirror 373b, and the fθ lens 375 to be radiated to the workpiece 20. The laser processing processor 310 performs helical processing.

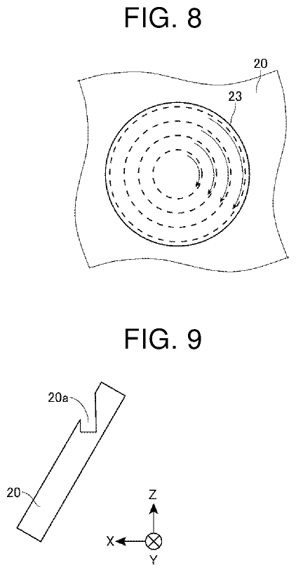

FIG. 8 is an explanatory view of helical processing. In FIG. 8, an area irradiated with the laser light on the front surface of the workpiece 20 to form the processing portion 20c is shown as a processing area 23, and FIG. 8 is a view of the processing area 23 viewed from the fθ lens 375 side. The broken lines shown in FIG. 8 show a plurality of circular irradiation lines located at regular intervals in a substantially concentric circle in the processing area 23, and the laser light is radiated to the respective irradiation lines in the helical processing. In FIG. 8, to clearly show the outermost circular irradiation line, the irradiation line is shifted to the inside of the processing area 23. The inside of the irradiation line becomes the processing area 23. The respective arrows shown in FIG. 8 indicate the travel direction of the laser light which is radiated to the respective irradiation lines. In the helical processing, after being radiated as tracing the outermost irradiation line at least one turn, the laser light is radiated as tracing on the first-inner irradiation line from the outermost irradiation line at least one turn. The irradiation line to which the laser light is radiated is gradually shifted inward, and the laser light is finally traced on and radiated to the innermost irradiation line. The above-described trace of the laser light is controlled by the orientations of the mirrors 371b, 373b via the swing angles of the swing shaft of the drive units 371a, 373a. Therefore, the irradiation spot of the laser light moves in the in-plane direction of the projection surface of the processing area 23 at a certain height position, and the entire area of the processing area 23 is irradiated with the laser light. In this irradiation, at least a part of each irradiation spot of the laser light overlaps another irradiation spot adjacent to the irradiation spot. Here, “adjacent” means in the circumferential direction and the radial direction of the irradiation line. When the shutter 170 is opened, the workpiece 20 is irradiated with the laser light, and the helical processing is performed, the laser processing processor 310 advances the control flow to step SP14.

### Step SP14

The laser processing processor 310 sets the stage 350 such that the beam waist of the laser light is shifted by a predetermined amount in the Z direction from the front surface of the workpiece 20 toward the back surface of the workpiece 20. When the setting is performed, the stage 350 moves the table 351 on which the workpiece 20 is placed so that the laser light is concentrated at a position shifted by the predetermined amount in the Z direction. When the movement of the table 351 is completed, the stage 350 transmits a signal indicating the completion to the laser processing processor 310. Upon receiving the signal, the laser processing processor 310 advances the control flow to step SP15.

### Step SP15

The laser processing processor 310 determines whether or not the current coordinate Z of the table 351 satisfies Z≥Z0+teff. The laser processing processor 310 returns the control flow to step SP13 and continues the processing when the current coordinate Z does not satisfy Z≥Z0+teff, and terminates the control flow when the current coordinate Z satisfies Z≥Z0+teff.

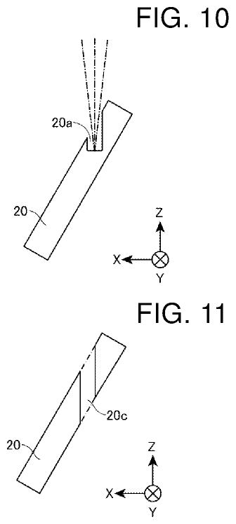

In the above control flowchart, when the control flow proceeds to step SP13 for the first time, step SP13 is a first process of concentrating the laser light on the front surface of the workpiece 20 to form the recessed portion 20a as shown in FIGS. 7 and 9. Further, when the control flow proceeds in the order of steps SP13, SP14, and SP15, and returns from step SP15 to step SP13 as the current coordinate Z does not satisfy Z≥Z0+teff, step SP13 for the second time or later is a second process of concentrating the laser light on the bottom surface of the recessed portion 20a, as shown in FIG. 10. In the second process, by the fluence Fb satisfying the expression of Fb≥Fmth, even when the beam waist of the laser light is at any height position, ablation occurs and a defect occurs when the laser light is concentrated on the bottom surface of the recessed portion 20a. This increases the depth of the recessed portion 20a. Step SP13 for the last time among steps S13 for the second time and later is the second process which is performed at a position where the processing depth of the workpiece 20 in the optical axis direction is deepest. In step SP13 for the last time, the current coordinate Z of the table 351 is Z0+teff, and the fluence Fin satisfies the expression of Ffth<Fin<Fmth. Since the fluence Fin is larger than the fluence Ffth, as shown in FIG. 3, even when the wall surface 20e on the upper end side of the recessed portion 20a is irradiated with the laser light, the chemical reaction between the workpiece 20 and the atmosphere is suppressed, and formation of a film (not shown) on the wall surface 20e due to the chemical reaction film (not shown) is suppressed. Further, since the fluence Fin is smaller than the fluence Fmth, unnecessary processing of the workpiece 20 is suppressed as compared with a case in which the fluence Fmth is not set as the upper limit. When step SP13 for the last time is completed, as shown in FIG. 11, a through hole being the processing portion 20c is formed in the workpiece 20. In the first process and the second process, since the in-plane direction of the front surface of the workpiece 20 is inclined with respect to the optical axis of the laser light, the through hole is formed as being inclined with respect to the in-plane direction. Here, step SP14 is a third process to move the table 351 on which the workpiece 20 is arranged in a direction opposite to the travel direction of the laser light between the first process and the second process.

### 3.3 Effect

In step SP13 for the second time and later as the second process of the laser processing method of the present embodiment, the fluence Fin satisfies the expression of Ffth<Fin<Fmth. Further, in the laser processing system 10 of the present embodiment, the optical system 330 causes the workpiece 20 to be irradiated with the laser light having the fluence Fin satisfying the expression of Ffth<Fin<Fmth.

When the workpiece 20 is irradiated with the laser light having the fluence Fin being equal to or less than the fluence Ffth, the workpiece 20 may chemically react with the atmosphere, and a film may be formed on the workpiece 20 by the chemical reaction. However, in the above configuration, since the fluence Fin is larger than the fluence Ffth, the chemical reaction is suppressed and the formation of the film can be suppressed. Further, as the fluence Fin is increased, the formation of the film is suppressed but the workpiece 20 may be unnecessarily processed such that the upper end of the recessed portion 20a is cut. However, in the above configuration, since the fluence Fin is smaller than the fluence Fmth, unnecessary processing of the workpiece 20 can be suppressed as compared with a case in which the fluence Fmth is not set as the upper limit.

Further, in the laser processing method of the present embodiment, the in-plane direction of the front surface of the workpiece 20 is inclined with respect to the optical axis in the first process and the second process, which is step SP13 to which the control flow proceeds for the first time.

According to the above configuration, the processing portion 20c may be formed to be inclined with respect to the in-plane direction of the front surface.

Further, in the laser processing method of the present embodiment, in the first process and the second process, after any irradiation line among a plurality of concentric irradiation lines is irradiated with the laser light at least one turn, another irradiation line among the plurality of irradiation lines is irradiated with the laser light at least one turn. That is, helical processing is performed in the first process and the second process.

Examples of the processing of forming, for example, a circular through hole in the workpiece 20 as the processing portion 20c includes raster scan processing other than helical processing. The raster scan processing is processing in which the laser light is linearly moved and radiated from the lower end of the through hole toward the upper end, when the through hole is viewed from the front side in the left-right direction. In this case, the irradiation line to be traced by and irradiated with the laser light is gradually shifted upward. When a circular hole is formed, the helical processing is easier to form the through hole than the raster scan processing.

Further, in the laser processing method of the present embodiment, the fluence Ffth and the fluence Fmth are calculated in advance by sample processing of the workpiece 20.

According to the above configuration, the processing time can be shortened as compared with a case in which the fluence Ffth and the fluence Fmth are calculated at the time of processing the workpiece 20.

Further, in the laser processing method of the present embodiment, the laser light for irradiation of the workpiece 20 is output from the gas laser device 100 which is an excimer laser device.

According to the above configuration, as compared with the case in which the laser light is output from a device other than the excimer laser device, the wavelength of the laser light is easily shortened, the energy of the laser light is easily increased, and the divergence angle of the laser light is easily suppressed. When the divergence angle is suppressed, the focal depth at the workpiece 20 becomes deeper, so that processing with the laser processing method is easily performed on the workpiece 20 having a deep recessed portion 20a at the front surface of the workpiece 20, the workpiece 20 having a high convex portion on the front surface of the workpiece 20, and the workpiece 20 having a large thickness,

Further, the wavelength of the laser light for irradiation of the workpiece 20 is a wavelength narrowed so as not to include an absorption line of oxygen.

According to the above configuration, when the workpiece 20 is arranged at the internal space of the housing 355, an inert gas such as a nitrogen gas is not necessarily required to constantly flow at the internal space during processing. Further, when the workpiece 20 is made of CMC, it is possible to perform processing with the laser light on CMC without flowing of the inert gas.

In the laser processing method of the present embodiment, each of the fluences Fin, Fmax is adjusted by the transmittance of the attenuator 333, but the present invention is not limited thereto. Each of the fluences Fin, Fmax may be adjusted, for example, by a voltage in the charger 141. In this case, the attenuator 333 may be omitted.

In the laser processing method of the present embodiment, the helical processing is used, but the processing portion 20c may be processed with the laser light concentrated at one point without being moved in the in-plane direction. Further, in the laser processing method according to the present embodiment, the in-plane direction of the front surface of the processing portion 20c is inclined with respect to the optical axis, but may be perpendicular to the optical axis.

### 4. Description of Laser Processing System and Laser Processing Method of Second Embodiment

Next, the laser processing system 10 and the laser processing method of a second embodiment will be described. Any component same as that described above is denoted by an identical reference sign, and duplicate description thereof is omitted unless specific description is needed.

### 4.1 Configuration

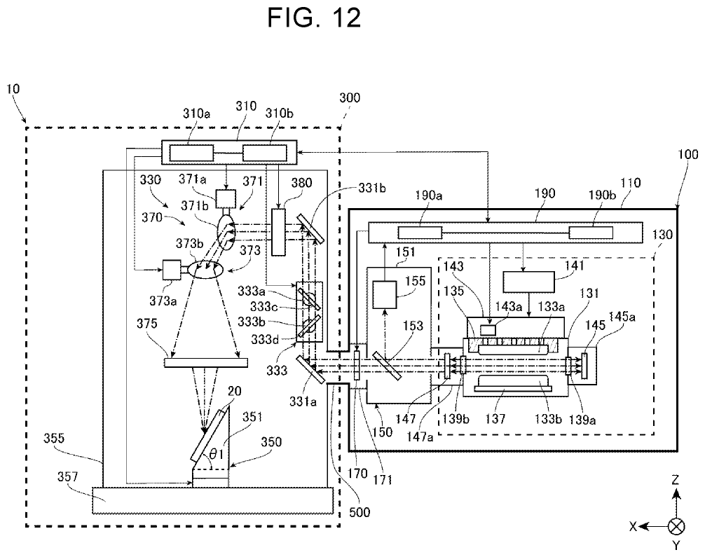

FIG. 12 is a schematic diagram showing a schematic configuration example of the entire laser processing system 10 of the present embodiment. In the laser processing system 10 of the present embodiment, the configuration of the optical system 330 of the laser processing device 300 is different from the configuration of the optical system 330 of the first embodiment. The optical system 330 of the present embodiment further includes a variable beam expander 380 arranged between the high reflection mirror 331b and the mirror 371b at the internal space of the housing 355 and electrically connected to the laser processing processor 310. In FIG. 12, the variable beam expander 380 is shown in a simplified manner.

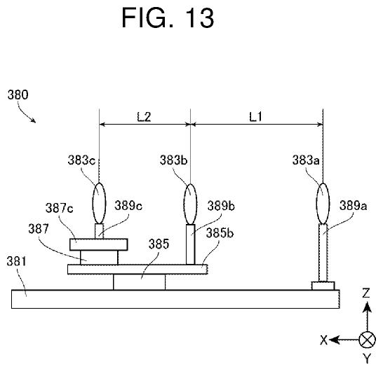

FIG. 13 is a schematic view showing a schematic configuration example of the variable beam expander 380. The variable beam expander 380 includes a base member 381, lenses 383a, 383b, 383c, stages 385, 387, and holders 389a, 389b, 389c holding the lenses 383a, 383b, 383c.

The holder 389a and the stage 385 are arranged on the base member 381. The holder 389b and the stage 387 are arranged on the table 385b of the stage 385. The holder 389c is arranged on the table 387c of the stage 387. The lenses 383a, 383b, 383c are arranged in this order from the high reflection mirror 331b toward the mirror 371b, and collimated light from the high reflection mirror 331b enters the lens 383a. The lenses 383a, 383b, 383c include a convex lens and a concave lens.

Each of the stages 385, 387 moves the corresponding table 385b, 387c in the X direction by a control signal from the laser processing processor 310, and adjusts the position of the corresponding lens 383b, 383c by this movement. By this adjustment, the distance L1 between the lens 383a and the lens 383b and the distance L2 between the lens 383b and the lens 383c are adjusted, and the laser light whose magnification ratio and the cross-sectional area at the beam waist are adjusted is output from the lens 383c as collimated light.

### 4.2 Operation

Next, operation of the laser processing processor 310 of the present embodiment will be described.

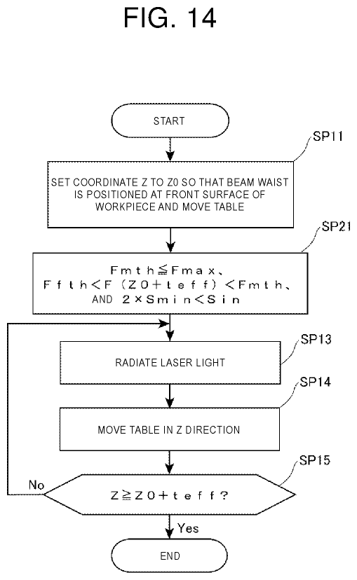

FIG. 14 is a diagram showing a control flowchart of the laser processing processor 310 of the present embodiment. The control flowchart of the present embodiment differs from the control flowchart of the first embodiment in that step SP21 is included instead of step SP12.

### Step SP21

In the present step, as in the first embodiment, the laser processing processor 310 sets the energy of the laser light such that the expression of Fmth≤Fmax is satisfied when the current coordinate Z of the table 351 is Z0, and the expression of Ffth<Fin=F(Z0+teff)<Fmth is satisfied when the current coordinate Z is Z0+teff. In the laser processing method of the present embodiment, the laser processing processor 310 adjusts the distances L1, L2 among the lenses 383a, 383b, 383c by the stages 385, 387, unlike the first embodiment. Therefore, the present step can be understood as a distance adjustment process to adjust the distances L1, L2 among the plurality of lenses 383a, 383b, 383c, of the variable beam expander 380, through which the laser light is transmitted so that the fluence Fin satisfies the expression of Ffth<Fin<Fmth. Thus, the fluences Fin, Fmax are coarsely adjusted. Further, for the purpose of setting the energy of the laser light, in the laser processing method of the present embodiment, the laser processing processor 310 adjusts the transmittance of the attenuator 333 through which the laser light is transmitted, as in the first embodiment. Thus, the fluences Fin, Fmax are finely adjusted. Further, when the current coordinate Z of the table 351 is Z0+teff, the variable beam expander 380 adjusts the cross-sectional area Sin and the cross-sectional area Smin so that the cross-sectional area Sin and the cross-sectional area Smin satisfy the following expression by adjusting the distances L1, L2.

2×Smin<Sin

After adjusting the distances L1, L2 and the transmittance, the laser processing processor 310 advances the control flow to step SP13.

### 4.3 Effect

The laser processing method of the present embodiment further includes the distance adjustment process of adjusting the distances L1, L2 among the lenses 383a, 383b, 383c so that the fluence Fin satisfies the expression of Ffth<Fin<Fmth.

According to the above configuration, the magnification ratio of the laser light transmitted through the lenses 383a, 383b, 383c and the cross-sectional area of the laser light at the beam waist of the laser light are adjusted, and the fluence Fin can satisfy the expression of Ffth<Fin<Fmth.

Here, when the energy of the laser light is sufficiently high, a variable aperture may be arranged instead of the variable beam expander 380, and the variable aperture may adjust the diameter of the laser light incident on the fθ lens 375. Alternatively, instead of the variable beam expander 380, a beam expander including plural types of lenses each having a fixed magnification may be arranged. Further, the variable beam expander 380 may be omitted, and instead of the fθ lens 375, a zoom lens capable of changing the focal length may be arranged. Further, instead of the zoom lens, plural types of light concentrating lenses each having a fixed focal length may be arranged.

### 5. Description of Laser Processing System and Laser Processing Method of Third Embodiment

Next, the laser processing system 10 and the laser processing method of a third embodiment will be described. Any component same as that described above is denoted by an identical reference sign, and duplicate description thereof is omitted unless specific description is needed.

### 5.1 Configuration

Since the configuration of the laser processing system 10 of the present embodiment is the same as the configuration of the laser processing system 10 of the second embodiment, description thereof will be omitted.

### 5.2 Operation

Next, operation of the laser processing processor 310 of the present embodiment will be described.

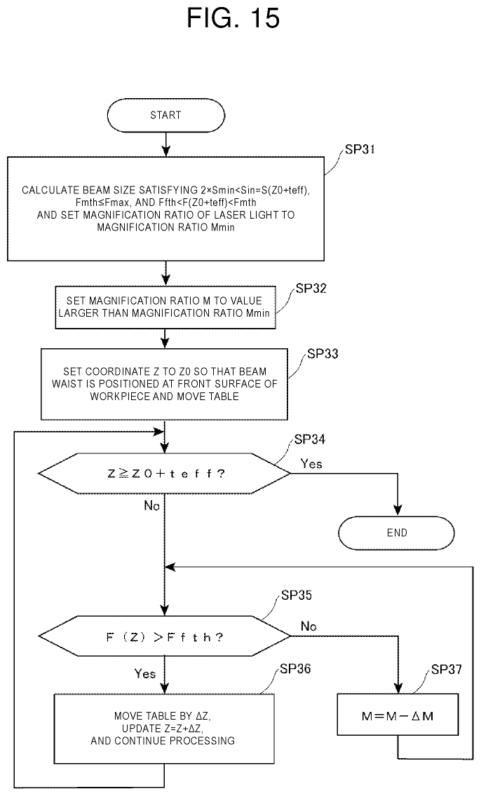

FIG. 15 is a diagram showing a control flowchart of the laser processing processor 310 of the present embodiment. The control flowchart of the present embodiment includes steps SP31 to SP37.

### Step SP31

In the present step, the laser processing processor 310 calculates the beam size of the laser light satisfying the expressions of 2×Smin<Sin=S(Z0+teff), Fmth≤Fmax, and Ffth<Fin=F(Z0+teff)<Fmth) in the adjustment range of the distances L1, L2 among the lenses 383a, 383b, 383c. The cross-sectional area S(Z0+teff) indicates the cross-sectional area Sin when the coordinate Z of the table 351 is Z0+teff. The fluence F(Z0+teff) indicates the fluence Fin when the coordinate Z of the table 351 is Z0+teff. Further, the laser processing processor 310 sets the magnification ratio of the laser light when 2×Smin<Sin=S(Z0+teff) as a magnification ratio Mmin. In other words, the laser processing processor 310 sets the magnification ratio when the effective processing depth is the deepest in advance to the magnification ratio Mmin. After setting the magnification ratio Mmin, the laser processing processor 310 advances the control flow to step SP32.

### Step SP32

In the present step, the laser processing processor 310 sets the magnification ratio M when the laser light is concentrated on the workpiece 20 to a value larger than the magnification ratio Mmin. Accordingly, the laser processing processor 310 adjusts the positions of the lenses 383b, 383c by the stages 385, 387, and the adjustment reduces the cross-sectional area of the laser light at the beam waist. After setting the magnification ratio M, the laser processing processor 310 advances the control flow to step SP33.

### Step SP33

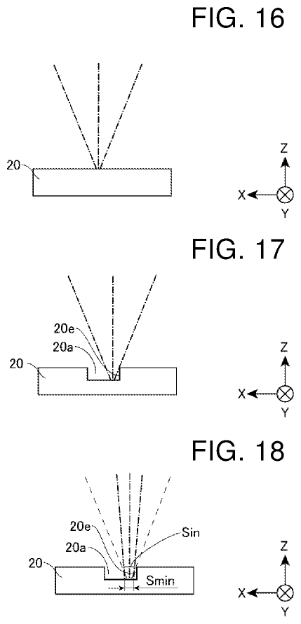

In the present step, similarly to step SP11, the laser processing processor 310 sets, to the stage 350, the coordinate X and the coordinate Y of the irradiation position to be irradiated with the laser light so that the processing portion 20c is formed at a desired position of the workpiece 20. Further, the laser processing processor 310 sets the coordinate Z of the table 351 to Z0 so that the beam waist of the laser light is positioned on the front surface of the workpiece 20. When the setting is performed, the stage 350 moves the table 351 on which the workpiece 20 is placed so that the set position is irradiated with the laser light. When the movement of the table 351 is completed, the stage 350 transmits a signal indicating the completion to the laser processing processor 310. Upon receiving the signal, the laser processing processor 310 transmits the light emission trigger Tr to the laser processor 190 and causes the laser processor 190 to open the shutter 170 similarly to step SP13. Thus, the workpiece 20 is irradiated with the laser light as shown in FIG. 16, and the laser processing processor 310 performs helical processing. In FIG. 16, the main surface of the workpiece 20 is shown along the XY plane for ease of understanding. By concentrating the laser light on the front surface of the workpiece 20, the recessed portion 20a (not shown in FIG. 16) is formed on the front surface of the workpiece 20. After the helical processing is performed, the laser processing processor 310 advances the control flow to step SP34.

### Step SP34

In the present step, upon receiving, from the stage 350, a signal indicating that movement of the table 351 is completed, the laser processing processor 310 determines whether or not the current coordinate Z of the table 351 satisfies Z≥Z0+teff. When Z≥Z0+teff is satisfied, the laser processing processor 310 terminates the processing and terminates the control flow. When Z≥Z0+teff is not satisfied, the processing is in progress, and thus the laser processing processor 310 advances the control flow to step SP35.

### Step SP35

In the present step, the laser processing processor 310 determines whether or not the fluence Fin satisfies the expression of Fin=F(Z)>Ffth. The fluence F(Z) indicates the fluence Fin at the current coordinate Z of the table 351. When Fin=F(Z)>Ffth is satisfied, generation of the film in the recessed portion 20a is suppressed, and thus the laser processing processor 310 advances the control flow to step SP36. When Fin=F(Z)>Ffth is not satisfied, a film (not shown) may be formed on the wall surface 20e by the chemical reaction as described above when the wall surface 20e on the upper end side of the recessed portion 20a is irradiated with the laser light having reduced fluence as shown in FIG. 17. In FIG. 17, similarly to FIG. 16, the main surface of the workpiece 20 is shown along the XY plane for ease of understanding. Then, the laser processing processor 310 advances the control flow to step SP37.

### Step SP36

In the present step, the laser processing processor 310 moves the table 351 by a predetermined amount ΔZ, updates the coordinate Z of the table 351 to Z+ΔZ, and continues the processing. When the movement of the table 351 is completed, the stage 350 transmits a signal indicating the completion to the laser processing processor 310. In the present step, when the coordinate Z of the table 351 is Z+ΔZ, the helical processing is performed.

After the helical processing is completed at the coordinate, the laser processing processor 310 returns the control flow to step SP34. When the current coordinate Z of the table 351 does not satisfy Z≥Z0+teff in step SP34, the control flow proceeds to step SP35. In step SP35, the laser processing processor 310 determines whether or not the fluence Fin at the current coordinate Z of the table 351 moved in step SP36 satisfies the expression of Fin=F(Z)>Ffth. Depending on the determination result in step SP35, the control flow proceeds to step SP36 or step SP37.

### Step SP37

In the present step, the laser processing processor 310 reduces the magnification ratio M by ΔM within a range in which the magnification ratio M satisfies M≥Mmin. The magnification ratio M is adjusted by adjusting the distances L1, L2 among the plurality of lenses 383a, 383b, 383c, of the variable beam expander 380, through which the laser light is transmitted. As the processing depth becomes deeper, the laser processing processor 310 gradually decreases the magnification ratio, thereby increasing the cross-sectional area Smin of the laser light at the beam waist and decreasing the cross-sectional area Sin of the laser light at the upper end of the recessed portion 20a, as shown in FIG. 18. In FIG. 18, the laser light shown in FIG. 17 is indicated by broken lines, and for ease of understanding, the main surface of the workpiece 20 is shown along the XY plane in the same manner as in FIGS. 16 and 17. This increases the fluence Fin at the upper end of the recessed portion 20a. When the fluence Fin is larger than the fluence Ffth, the formation of the film is suppressed. After decreasing the magnification ratio M, the laser processing processor 310 returns the control flow to step SP35.

In the present embodiment, step SP33 is the first process to concentrate the laser light on the front surface of the workpiece 20 to form the recessed portion 20a. Further, steps SP34 to SP37 are the second process to concentrate the laser light on the bottom surface of the recessed portion 20a.

### 5.3 Effect

In the second process of the present embodiment, as the processing depth of the workpiece 20 in the optical axis direction becomes deeper, the cross-sectional area of the laser light at the beam waist becomes larger. As the cross-sectional area of the laser light at the beam waist becomes larger, the fluence at the processing point becomes higher and the processing time becomes shorter.

### 6. Description of Gas Laser Device of Modification

Next, the gas laser device 100 of a modification of the above embodiments will be described. Any component same as that described above is denoted by an identical reference sign, and duplicate description thereof is omitted unless specific description is needed.

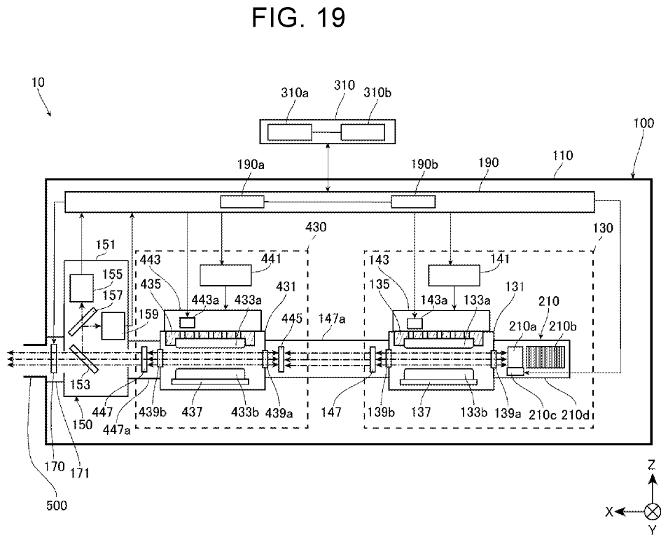

FIG. 19 is a schematic view showing a schematic configuration example of the entire gas laser device 100 of the modification.

In the gas laser device 100 of the present modification, the laser oscillator 130 is a master oscillator. In the laser oscillator 130, the gas laser device 100 of the present modification includes a line narrowing module 210 instead of the rear mirror 145. The line narrowing module 210 includes a housing 210d, a prism 210a arranged at the internal space of the housing 210d, a grating 210b, and a rotation stage 210c. The number of prisms is one in the present example, but is not particularly limited as long as at least one prism to be rotated by the rotation stage 210c is included.

The prism 210a expands the beam diameter of the light output from the window 139a of the laser chamber 131 and causes the light to be incident on the grating 210b. Further, the prism 210a also reduces the beam diameter of the reflection light of the grating 210b and returns the light to the internal space of the laser chamber 131 through the window 139a.

The surface of the grating 210b is configured of a material having a high reflectance, and a large number of grooves are formed on the surface at predetermined intervals. The cross sectional shape of each groove is, for example, a right triangle. The light incident on the grating 210b from the prism 210a is reflected by these grooves and diffracted in a direction corresponding to the wavelength of the light. The grating 210b is arranged in the Littrow arrangement, which causes the incident angle of the light incident on the grating 210b from the prism 210a to coincide with the diffraction angle of the diffracted light having a desired wavelength. Thus, light having a wavelength close to the desired wavelength returns into the laser chamber 131 via the prism 210a. Here, the incident angle of the light with respect to the grating 210b is changed by the orientation of the prism 210a around the Z axis by the rotation stage 210c. Therefore, by rotating the prism 210a, the wavelength of the light returning from the grating 210b to the laser chamber 131 via the prism 210a can be selected. Thus, the gas laser device 100 corresponds to a wavelength-variable laser device capable of changing the wavelength of the laser light to be output.

In the laser oscillator 130, the output coupling mirror 147 and the grating 210b arranged as sandwiching the laser chamber 131 configure a laser resonator, and the laser chamber 131 is arranged on the optical path of the laser resonator. Therefore, the light from the internal space of the laser chamber 131 reciprocates between the grating 210b of the line narrowing module 210 and the output coupling mirror 147 via the windows 139a, 139b and the prism 210a.

In the laser oscillator 130, the laser processor 190 controls the charger 141 and the switch 143a in the pulse power module 143 to apply a high voltage between the electrode 133a and the electrode 133b as in the first embodiment. When the high voltage is applied between the electrode 133a and the electrode 133b, discharge occurs between the electrode 133a and the electrode 133b. The laser medium in the laser chamber 131 is excited by the energy of the discharge, and the excited laser medium emits light when shifting to the ground state. A part of this light is ultraviolet rays and is transmitted through the window 139a. The transmitted light is transmitted through the prism 210a and is expanded in the travel direction of the light. Further, the light is wavelength-dispersed when the light is transmitted through the prism 210a, and is guided to the grating 210b. The light enters the grating 210b at a predetermined angle and is diffracted, and light having a predetermined wavelength is reflected by the grating 210b at a reflection angle same as the incident angle. The light reflected by the grating 210b propagates, via the prism 210a, from the window 139a to the internal space of the laser chamber 131. The wavelength of the light propagating to the internal space of the laser chamber 131 is line-narrowed so as not to include an absorption line of oxygen. The line-narrowed light causes stimulated emission of the laser medium in the excited state, and the light is amplified. The light is transmitted through the window 139b and travels to the output coupling mirror 147. A part of the light is transmitted through the output coupling mirror 147, and the remaining part of the light is reflected by the output coupling mirror 147, is transmitted through the window 139b, and propagates to the internal space of the laser chamber 131. The light having propagated to the internal space of the laser chamber 131 travels to the grating 210b as described above. Thus, the light having the predetermined wavelength reciprocates between the grating 210b and the output coupling mirror 147. The light is amplified every time the light passes through the discharge space at the internal space of the laser chamber 131, and laser oscillation occurs. A part of the laser light is transmitted through the output coupling mirror 147.

The gas laser device 100 further includes an amplifier 430 arranged on the optical path of the laser light between the output coupling mirror 147 of the laser oscillator 130 and the beam splitter 153 of the monitor module 150. The amplifier 430 is a power oscillator that amplifies the energy of the laser light output from the laser oscillator 130.

The amplifier 430 has substantially the same configuration as the laser oscillator 130. To distinguish the components of the amplifier 430 from the components of the laser oscillator 130, the components of the amplifier 430 are described as a laser chamber 431, a pair of electrodes 433a, 433b, an electrically insulating portion 435, a return plate 437, a pair of windows 439a, 439b, a charger 441, a pulse power module 443, a switch 443a, an output coupling mirror 447, and an optical path pipe 447a. The electrodes 433a, 433b cause discharge for amplifying the laser light from the laser oscillator 130. The pulse power module 443 is a voltage application circuit similarly to the pulse power module 143. The output coupling mirror 447 is arranged between the window 439b and the beam splitter 153 at the internal space of the optical path pipe 447a. The optical path pipe 447a has the same configuration as the optical path pipe 147a.

The amplifier 430 further includes a rear mirror 445 arranged between the window 439a and the output coupling mirror 147, and the output coupling mirror 447 and the rear mirror 445 configure a Fabry-Perot laser resonator. The output coupling mirror 447 and the rear mirror 445 reflect a part of the laser light and transmit the remaining part. The rear mirror 445 is arranged at the internal space of the optical path pipe 147a together with the output coupling mirror 147.

A beam splitter 157 and a wavelength monitor 159 are added to the monitor module 150 of the present modification.

The beam splitter 157 is arranged between the beam splitter 153 and the optical sensor 155, and reflects a part of the reflection light reflected by the beam splitter 153 and transmits the remaining part. The transmission light transmitted through the beam splitter 157 enters the optical sensor 155, and the reflection light reflected by the beam splitter 157 enters the wavelength monitor 159.

The wavelength monitor 159 is a well-known etalon spectrometer. The etalon spectrometer includes, for example, a diffusion plate, an air gap etalon, a light concentrating lens, and a line sensor. The etalon spectrometer generates interference fringes of the incident laser light by the diffusion plate and the air gap etalon, and forms an image of the generated interference fringes on a light receiving surface of the line sensor by the light concentrating lens. Then, a wavelength λ of the laser light is measured by measuring the interference fringes imaged on the line sensor. The wavelength monitor 159 is electrically connected to the laser processor 190, and outputs a signal indicating data related to the measured wavelength λ of the laser light to the laser processor 190.

Upon receiving the signal indicating the target energy Et, a target wavelength λt, and the like from the laser processing processor 310, the laser processor 190 controls the charge voltages of the chargers 141, 441 and the rotation of the rotation stage 210c so that the laser oscillation occurs at the target values. The target wavelength λt may be, for example, a wavelength, in the amplification region of ArF excimer laser light, which avoids the absorption lines of oxygen. Such a wavelength may be, for example, a wavelength of 193.4 nm.

Upon receiving the light emission trigger Tr from the laser processing processor 310, the laser processor 190 causes the laser oscillator 130 to laser-oscillate as described above and drives the amplifier 430 in synchronization with the laser oscillator 130. At this time, the laser processor 190 turns On the switch 443a of the pulse power module 443 of the amplifier 430 so that discharge occurs when the laser light output from the laser oscillator 130 enters the discharge space in the laser chamber 431 of the amplifier 430. As a result, the laser light entering the amplifier 430 is amplified and oscillated in the amplifier 430.

The laser light amplified and output by the amplifier 430 travels to the monitor module 150, and the energy and the wavelength of the light are measured by the monitor module 150. The laser processor 190 controls the charge voltages of the charger 141 and the charger 441, and the line narrowing module 210 so that the actual measurement values of the energy and wavelength approach the target energy Et and the target wavelength λt, respectively.

When the laser processor 190 opens the shutter 170, the laser light transmitted through the beam splitter 153 of the monitor module 150 enters the laser processing device 300.

The wavelength of the laser light is line-narrowed so as not to include the absorption lines of oxygen. Therefore, in the laser processing device 300, it is not necessary that the inert gas, which is a nitrogen gas, always flows at the internal space of the housing 355 in which the workpiece 20 is arranged during the operation of the laser processing system 10. Further, it is possible to perform processing with the laser light on CMC without flowing of the inert gas.

Here, since a high energy is often required for laser processing, it is possible to increase the energy of the laser light by providing the amplifier 430 as in the gas laser device 100 of the present example. Further, when using a line-narrowed laser light for laser processing as in the present example, compared with the case of using laser light of natural oscillation, the energy is decreased. In the gas laser device 100 of the present example, the decrease in the energy can be suppressed by the amplifier 430.

In the present example, a Fabry-Perot resonator is used as the amplifier 430, but a ring resonator may be used as well. Further, the amplifier 430 may include a convex mirror and a concave mirror instead of the output coupling mirror 447 and the rear mirror 445.

The laser oscillator 130 may include a semiconductor laser which outputs seed light, a titanium sapphire amplifier which amplifies the seed light, and a wavelength conversion system.

The semiconductor laser is a distributed feedback type semiconductor laser which outputs, as seed light, continuous wave (CW) laser light, which is laser light continuously oscillating at a wavelength of 773.6 nm. By changing the temperature setting of the semiconductor laser, the oscillation wavelength can be changed.

The titanium sapphire amplifier includes a titanium-sapphire crystal and a pumping pulse laser device. The titanium sapphire crystal is arranged on the optical path of the seed light. The pumping pulse laser device is a laser device for outputting second harmonic light of a YLF laser.

The wavelength conversion system is a wavelength conversion system which generates fourth harmonic light having a center wavelength in the vicinity of 193.4 nm, and includes an LBO (LiB₃O₅) crystal and a KBBF (KBe₂BO₃F₂) crystal which performs wavelength conversion from the fundamental wave to the fourth harmonic light. Each crystal is arranged on a rotation stage (not shown), and is configured to change an incident angle of the seed light with respect to each crystal.

The laser oscillator 130 may include a solid-state laser device which outputs ultraviolet laser light having a center wavelength in the vicinity of 193.4 nm, and a wavelength conversion system including a nonlinear crystal. In this case, the laser oscillator 130 corresponds to a wavelength-variable laser device, and does not need to oscillate the laser light in the amplifying region of the ArF laser, and is simply required to oscillate the laser light within the wavelength range of 175.0 nm to 250.0 nm.

The description above is intended to be illustrative and the present disclosure is not limited thereto. Therefore, it would be obvious to those skilled in the art that various modifications to the embodiment of the present disclosure would be possible without departing from the spirit and the scope of the appended claims. Further, it would be also obvious to those skilled in the art that embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. A laser processing method comprising:
a first process to concentrate laser light on a front surface of a workpiece to form a recessed portion; and
a second process to concentrate the laser light on a bottom surface of the recessed portion,
in the second process, a fluence Fin satisfying an expression of Ffth<Fin<Fmth, where Fin represents a fluence of the laser light at an upper end of the recessed portion, Ffth represents a fluence being an upper limit with which a film is formed by a chemical reaction between the workpiece and the atmosphere due to irradiation with the laser light, and Fmth represents a fluence being a lower limit with which the laser light is capable of processing the workpiece.

2. The laser processing method according to claim 1,
further comprising a transmittance adjustment process to adjust a transmittance of an attenuator through which the laser light is transmitted so that the fluence Fin satisfies the expression.

3. The laser processing method according to claim 1,
further comprising a distance adjustment process to adjust a distance among a plurality of lenses, of the variable beam expander, through which the laser light is transmitted so that the fluence Fin satisfies the expression.

4. The laser processing method according to claim 3,
wherein the variable beam expander adjusts a cross-sectional area Sin and a cross-sectional area Smin so that the cross-sectional area Sin and the cross-sectional area Smin satisfy an expression of 2×Smin<Sin through the adjustment of the distance where Sin represents a cross-sectional area of the laser light at the upper end of the recessed portion, and Smin represents a cross-sectional area of the laser light at a beam waist of the laser light.

5. The laser processing method according to claim 1,
wherein a through hole is formed in the second process.

6. The laser processing method according to claim 1,
wherein, in the first process and the second process, an in-plane direction of the front surface is inclined with respect to an optical axis of the laser light.

7. The laser processing method according to claim 1,
further comprising a third process, between the first process and the second process, to move a table on which the workpiece is arranged in a direction opposite to a travel direction of the laser light traveling toward the workpiece.

8. The laser processing method according to claim 1,
wherein, in the first process and the second process, after any irradiation line among a plurality of concentric irradiation lines is irradiated with the laser light at least one turn, another irradiation line among the plurality of irradiation lines is irradiated with the laser light at least one turn.

9. The laser processing method according to claim 1,
wherein the second process is performed at a position where a processing depth of the workpiece in the optical axis direction is deepest.

10. The laser processing method according to claim 1,
wherein, in the second process, a cross-sectional area of the laser light at a beam waist of the laser light becomes larger as a processing depth of the workpiece in an optical axis direction becomes deeper.

11. The laser processing method according to claim 10,
wherein the cross-sectional area of the laser light at the beam waist is adjusted by adjusting a distance among a plurality of lenses, of the variable beam expander, through which the laser light is transmitted.

12. The laser processing method according to claim 1,
wherein the fluence Ffth and the fluence Fmth are calculated in advance by sampling processing of the workpiece.

13. The laser processing method according to claim 1,
wherein a processing depth of the workpiece in an optical axis direction is larger than a Rayleigh length of the laser light.

14. The laser processing method according to claim 1,
wherein the laser light is output from an excimer laser device.

15. The laser processing method according to claim 1,
wherein the fluence Ffth is 1 J/cm²or more and 2 J/cm² or less.

16. The laser processing method according to claim 1,
wherein a wavelength of the laser light is a wavelength line-narrowed so as not to include an absorption line of oxygen.

17. The laser processing method according to claim 1, wherein the workpiece is made of a ceramic matrix composite.

18. A laser processing system comprising:
an optical system which radiates laser light, and
an fθ lens which concentrates the laser light traveling from the optical system on a front surface of a workpiece,
the optical system performing irradiation with the laser light having a fluence Fin which satisfies an expression of Ffth<Fin<Fmth where Fin represents a fluence of the laser light at an upper end of a recessed portion to be formed by concentration of the laser light on the front surface, Ffth represents a fluence being an upper limit with which a film is formed by a chemical reaction between the workpiece and the atmosphere due to irradiation with the laser light, and Fmth represents a fluence being a lower limit with which the laser light is capable of processing the workpiece.
